(19) United States
(12) Patent Application Publication
(10) Pub. No.: US 2006/0292473 A1
(43) Pub. Date: Dec. 28, 2006

(54) Electrostatic latent image developing toner

(75) Inventors: Yasuo Kadokura, Minamiashigara-shi (JP); Yuka Ishihara, Minamiashigara-shi (JP); Yasuhiro Arima, Minamiashigara-shi (JP); Atsushi Sugawara, Minamiashigara-shi (JP); Shinya Nakashima, Minamiashigara-shi (JP); Masaki Nakamura, Minamiashigara-shi (JP); Yasuhiro Oya, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/302,151

(22) Filed: Dec. 14, 2005

(30) Foreign Application Priority Data
Jun. 27, 2005 (JP) 2005-187457

(51) Int. Cl. G03G 9/08

(52) U.S. Cl. 430/108.6; 430/108.1; 430/109.4

(57) ABSTRACT

An electrostatic latent image developing toner that is made by adding electrically conductive powder as an external additive to toner particles comprising a binder resin and a colorant, wherein the liberation rate of the electrically conductive powder is from 50 to 90%; and the number average particle size distribution index G of the toner particles, which is represented by the following formula (1), is 1.20 or less.
particle size distribution index G=D50/D16 Formula (1) And an electrostatic latent image developing toner that is made by adding a metal oxide as an external additive to toner particles comprising a binder resin and a colorant, wherein the liberation rate of the metal oxide is from 30 to 60%.

### CROSS-REFERENCE TO RELATED APPLICATION

This application claims priority under 35 USC 119 from Japanese Patent Application No. 2005-187457, the disclosure of which is incorporated by reference herein.

### BACKGROUND OF THE INVENTION

1. Field of the Invention

The present invention relates to electrostatic latent image developing toner that is suitably used in an image forming device employing the electro-photography method and effectively prevents filming that occurs particularly on a latent image carrier.

2. Description of the Related Art

In the electro-photography method, an electrostatic latent image formed on a latent image carrier (a photoreceptor) is developed with the use of the toner containing a colorant, and the obtained toner image is transferred on the transfer material and then the transferred image is fixed with a heating roll and the like to give an image. On the other hand, in the electro-photography method, the latent image carrier is cleaned to form an electrostatic latent image again.

Generally, all of the toner that has been developed are not transferred, but there are some of the toner remained on the photoreceptor. As for the problem, the following kinds of toner can be exemplified. as the causes, that is, toner with high adhesive power that is in surface contact or multipoint contact with the photoreceptor such that amorphous toner as made by a kneading and pulverizing method, or like toner that some of its toner particles have been fusion bonded due to agitation stress within the developing machine and be aggregated, and toner that its adhesive power with the photoreceptor is increased because of small particle size and being highly charged with electricity not to be transferred even if being developed.

In recent years, many kinds of toner that are made by polymerization methods, which can make toner with uniform particle size, have been introduced. However, there exists some toner that becomes aggregated from the beginning because of non-uniformity in the manufacture of the toner and non-uniformity of the material used, even if the toner has never been subjected to stress within the developing machine as described above. In addition, efforts for making toner with small particle size have been positively performed to obtain a high quality image. However, in practice there also exists toner with small particle size that has distribution in the particle seize. Furthermore, toner aiming at being fixed at low temperatures has been proposed to increase copy productivity. However, this toner is generally soft, and there exists consequently such toner that is easily fusion bonded due to stress within the developing machine. As described above, there will exist toner remaining on a photoreceptor regardless of its manufacturing process.

The so-called “untransferred residual toner” remained on a photoreceptor will be removed with a cleaner system such as a blade mounted on the photoreceptor. On this occasion, toner with an amorphous shape is easily removed, however toner with small particle size has become problematic because it easily causes a poor cleaning property.

Furthermore, in case of being cleaned with a blade, untransferred residual toner is intercepted at the nip part of the blade and cleaned. However, even the amorphous toner are combined with toner with small particle size to form a toner mass (hereinafter, it may be referred to as a “toner dam”) on the cleaning blade. For this reason, the total amount of force added on the blade at the time of cleaning sometimes becomes large. As a result, the force added on toner in the toner dam part from the cleaning blade becomes strong to make the toner adhere to the photoreceptor, causing filming.

In addition, rather soft toner aiming at being fixed at low temperatures is also easily made adhere to the photoreceptor by the force added from the cleaning blade.

Moreover, when the toner in which an external additive has been added is subjected to stress within the developing machine, the external additive becomes generally harder than the toner. For this reason, the external additive is apt to be buried in the toner. The toner in which an external additive has been buried comes to have a large surface contacting with the photoreceptor and is easily remained on the photoreceptor because of increasing in the adhesive power. As a result, the total amount of the force added on the blade during cleaning becomes large to make the toner adhere to the photoreceptor, causing filming. In cleaning methods other than that using a blade, in case of removing pollutants on the surface of the photoreceptor by rubbing the surface, there exist the same defects.

In order to prevent the filming, it is considered to take a measure of reducing untransferred residual toner. For example, a method of controlling untransferred residual toner by prescribing the content of a liberated external additive has been disclosed in Japanese Patent Application Laid-Open (JP-A) Nos. 2001-22118 and 2002-278261. However, the method is not satisfactory from the viewpoint of the reliability over a long period of time because the external additive is buried in the toner. Even if untransferred residual toner is reduced, finally a toner mass is produced in the blade part to cause filming.

Furthermore, there is a method in which electrically conductive powder is added as an auxiliary agent for cleaning. But, although the method is suitable for cleaning toner adhered on the photoreceptor, it causes a risk of scratching the surface of the photoreceptor. As a result, powder in the toner is trapped within the scratches on the surface of the photoreceptor to make the cleaning of the toner difficult, leading to the occurrence of filming. A method for prescribing the liberation rate of the electrically conductive powder has been disclosed in Japanese Patent Application Laid-Open (JP-A) No. 2004-126575. However, the method was not in the satisfactory level because of having no effect for the prevention of filming depending on toner particles to be used.

### SUMMARY OF THE INVENTION

According to the present invention, the occurrence of filming can be effectively prevented.

A first aspect of the present invention is to provide an electrostatic latent image developing toner that is made by adding electrically conductive powder as an external additive to toner particles comprising a binder resin and a colorant, wherein the liberation rate of the electrically conductive powder is from 50 to 90%; and

the number average particle size distribution index G of the toner particles, which is represented by the following formula (1), is 1.20 or less,
particle size distribution index G=D50/D16 Formula (1)
wherein the D 16 indicates the number average particle diameter of 16% that is the 16th percentile of the particle size distribution measured from the smallest particle size and the D50 indicates the number average particle diameter of 50% that is the 50th percentile of the particle size distribution measured from the smallest particle size.

A second aspect of the present invention is provide an electrostatic latent image developing toner that is made by adding a metal oxide as an external additive to toner particles comprising a binder resin and a colorant, wherein the liberation rate of the metal oxide is from 30 to 60%.

### DETAILED DESCRIPTION OF THE INVENTION

The present invention is achieved to eliminate defects in the conventional methods, that is, the invention can provide electrostatic latent image developing toner that can effectively prevent the occurrence of filming.

The electrostatic latent image developing toner of the invention (hereinafter, this toner is referred to as “the first toner”) is electrostatic latent image developing toner that is made by adding electrically conductive powder as an external additive to toner particles comprising a binder resin and a colorant, wherein

the liberation rate of the electrically conductive powder is from 50 to 90% ; and,

the number average particle size distribution index G of the toner particles, which is represented by the following formula (1), is 1.20 or less,
particle size distribution index G=D50/D16 Formula (1)
wherein the D16 indicates the number average particle diameter of 16% that is the 16th percentile of the particle size distribution measured from the smallest particle size and the D50 indicates the number average particle diameter of 50% that is the 50th percentile of the particle size distribution measured from the smallest particle size.

The first toner can more effectively remove untransferred residual toner, that is remained on a photoreceptor at the time of forming images, by liberating electrically conductive powder at a specified rate and furthermore prescribing the particle size distribution of the toner.

The mechanism is considered to be as follows. Electrically conductive powder, a liberated external additive, is accumulated at a cleaning part placed on a photoreceptor. As a result, the toner remained on the photoreceptor is removed by pulverizing the surface of the photoreceptor, before the untransferred residual toner that has been remained on the photoreceptor forms toner dams. In conventional techniques, the toner is trapped in minute scratches produced on the surface of the photoreceptor on this occasion and is pressed to the blade and the like, which causes the occurrence of filming. However in the first toner, the toner is not trapped in minute scratches on the photoreceptor by controlling the particle size distribution of the toner, resulting in preventing the occurrence of filming.

Furthermore, the electrostatic latent image developing toner in the other aspect of the invention is electrostatic latent image developing toner that is made by adding a metal oxide as an external additive to toner particles comprising a binder resin and a colorant, wherein the liberation rate of the metal oxide is from 30 to 60%.

The second toner can more effectively remove untransferred residual toner, that is remained on a photoreceptor at the time of forming images, by liberating the specified amount of the metal oxide that is an external additive.

The mechanism is considered to be as follows. The liberated metal oxide, an external additive, is very highly charged with electricity and adheres to the photoreceptor at the time of forming a toner image in the developing process and is difficult to be transferred. Consequently the liberated metal oxide is accumulated at a cleaning part placed on a photoreceptor. As a result, untransferred residual toner that is remained on the photoreceptor adheres to the liberated metal oxide before forming a toner dam by untransferred residual tone that is remained on the photoreceptor, which makes it easy to clean the residual toner, resulting in preventing the occurrence of filming.

In the following, on the occasion of the detailed description of the invention, first, characteristic parts of the first toner and the second toner of the invention will be described in detail, and then the composition, the manufacturing method and the like in common for both of the first toner and the second toner will be described.

The First Toner

The Number Average Particle Size Distribution Index

In the first toner of the invention, it is an essential condition that the number average particle size distribution index G of the toner particles, which is represented by the following formula (1), is 1.20 or less:
particle size distribution index G=D50/D16 Formula (1)
wherein the D16 indicates the number average particle diameter of 16% that is the 16th percentile of the particle size distribution measured from the smallest particle size and the D50 indicates the number average particle diameter of 50% that is the 50th percentile of the particle size distribution measured from the smallest particle size.

The value of the number average particle size distribution index G is further preferable to be 1.18 or less, and particularly preferable to be 1.17 or less. When the number average particle size distribution index G is more than 1.20, toner is trapped in minute scratches on the surface of the photoreceptor to cause the occurrence of filming on the surface of the photoreceptor. Further, though the lower limit value is not especially limited, the value is generally preferable to be 1.13 or more from the viewpoint of manufacturing. The method for measuring the average particle size of the toner particles The measurement of the number average particle size is carried out by the following means.

Coulter Multisizer II-type (manufactured by Beckman Coulter, Inc.) is used as the measuring device, and ISOTON-II (manufactured by Beckman Coulter, Inc.) is used as the electrolysis solution.

As the measurement method, 10 mg of a sample is added in 2 ml of 5% aqueous solution of a surfactant (sodium alkyl benzene sulfonate) as a dispersing agent. This is added in 100 ml of the electrolysis solution. The electrolysis solution suspending the sample is subjected to dispersed processing for 1 minute with an ultrasonic disperser and then the particle size distribution of the particles having particle size of 2 to 60 μm is measured with the Coulter Multisizer II type using an aperture of 1001 μm in diameter to give the number average distribution. The number of particles to be measured is 50,000.

Then, the particle size distribution of toner is defined as follows: about measured particle distribution, the number cumulative distribution is made by distributing the number of particles from the small particle size to the divide ranges of particle sizes (channels), and D16 means the number average particle size that the accumulation is 16% and D50 means the number average particle size that the accumulation is 50%.

As a method for controlling the number average particle size distribution index G in the range, there is a method in which both of the metal salt and metal salt polymer of inorganic acid are used as flocculants in case of manufacturing toner particles. Though the reason is not clear, particles to be used for toner have certain degree of particle size distribution and particles in a region of small particle size distribution, concretely, in the range of 10 to 150 nm can be flocculated by metal salt of inorganic acid, and particles in the range of about 150 to 300 nm can be flocculated by a metal salt polymer. As a result, because the method can be applied to a certain degree of particle size distribution, it is considered that the range of the particle size distribution index G can be achieved.

Further, specific examples of the metal salt of inorganic acid include acids including hydrochloric acid, sulfuric acid, nitric acid, acetic acid, and oxalic acid; magnesium chloride; sodium chloride; aluminum sulfate; calcium sulfate; ammonium sulfate; aluminum nitrate; silver nitrate; copper sulfate; and sodium carbonate. Aluminum sulfate is suitably used because it is colorless and transparent and has strong cohesive force.

And, specific examples of the metal salt polymers include polyaluminum chloride and polyaluminum hydroxide and particularly polyaluminum chloride is suitably used. The liberation rate of the electrically conductive powder Furthermore, in the first toner of the invention, it is an essential condition that at least electrically conductive powder is added as an external additive and the liberation rate of the electrically conductive powder is in the range of 50 to 90%. And, in addition, the liberation rate of the electrically conductive powder is preferable in the range of 55 to 85%, and particularly preferable in the range of 60 to 80%.

Because the liberation rate of the electrically conductive powder is in the range of 50 to 90%, untransferred residual toner on the photoreceptor can be well removed before that untransferred residual toner forms a toner dam and can effectively prevent the occurrence of filming. When the liberation rate of the electrically conductive powder is less than 50%, the removal of untransferred residual toner is less effective and the effect of removing a toner dam that is a cause of the occurrence of filming cannot be obtained. And, when the liberation rate of the electrically conductive powder is more than 90%, too heavy loads are applied on cleaning devices including a blade and adversely affect their maintenance.

The Method for Measuring the Liberation Rate

Further, the liberation rate of the electrically conductive powder is measured as described below.

First, the elementary analysis of each particle in the toner (toner particles or liberated electrically conductive powder) is carried out with Particle Analyzer PT-1000 (manufactured by Yokokawa Denki Co., Ltd.) to obtain data of 1000 pieces of particles. Further, helium gas is used in the measurement with Particle Analyzer PT-1000. When the light-emitting voltage of carbon derived from the binder resin in toner particles is X and the light-emitting voltage caused by an element derived from an external additive is Y, liberated electrically conductive powder is detected at X=0. Based on the data obtained in such a way, the liberation rate will be obtained from the number of liberated electrically conductive powder in the 1000 pieces of particles.

As a method for controlling the liberation rate of electrically conductive powder in the range, controlling by adjusting the surface hardness of toner particles can be used. Generally, an external additive is apt to flocculate, and the aggregate of an external additive adheres while it is destroyed by being stirred with toner particles when it adheres to the toner surface. At this time, if the hardness of the toner surface is low, the external additive is buried into the toner. To the contrary, if the hardness is high, the aggregate becomes difficult to be destroyed. Accordingly, as a reason of destroying agglomerated particles of the external additive, it is estimated that the aggregation is destroyed because the contact surface of the external additive with the toner surface are buried to some degree. Therefore, the hardness of the toner surface can be increased while the hardness of the toner inside is kept low to some degree by making the molecular weight of the surface part of the toner larger compared to that of the inner part. Consequently, when the toner collides with agglomerated particles of the external additive, though the hardness of the toner surface is high, stress generated in the inner part moderately suppresses the influence of the surface hardness and thereby can control the liberation rate while the aggregate of the external additive is destroyed.

Then, specific examples of the electrically conductive powder will be cited. As electrically conductive powders that can be used according to the invention, for example, out of metal powders including copper, gold, silver, aluminum and nickel; metal oxides including zinc oxide, titanium oxide, tin oxide, aluminum oxide, indium oxide, silicon oxide, magnesium oxide, barium oxide, molybdenum oxide, iron oxide, tungsten oxide and cerium oxide; metal compounds including molybdenum sulfide, cadmium sulfide and potassium titanate; or these composite oxides and the like; electrically conductive powders having aggregates of primary particles can be used. Among these, cerium oxide is preferable from the view point of the resistance and the transmissivity. Further, it is also preferable to use electrically conductive powder with adjusted particle size distribution to adjust particle size and particle size distribution as a developer.

Furthermore, besides the electrically conductive powder, in order to control the fluidity and chargeability of toner, it is preferable to add any other additive to coat sufficiently the surface of toner particles. As other additives to be used, inorganic compounds and organic powders can be exemplified. As inorganic compounds, for example, all particles generally used as external additives for the toner surface including alumina, titania, calcium carbonate, magnesium carbonate, tricalcium phosphate and cerium oxide can be exemplified., as organic powders, for example, all particles generally used as external additives for the toner surface including polyvinyl resins, polyester resins, silicone resins and fluorocarbon resins can be exemplified. Moreover, a lubricant may be added. As lubricants, for example, fatty amides including ethylenebisstearic amide and oleic amide, and fatty metal salts including zinc stearate and calcium stearate, can be exemplified.

The Second Toner

Then, the second toner of the invention will be described.

In the second toner of the invention, it is an essential condition that at least a metal oxide is added as an external additive and the liberation rate of the metal oxide is in the range of 30 to 60%. And, in addition, the liberation rate of the metal oxide is preferable in the range of 35 to 60%, and particularly preferable in the range of 40 to 60%.

Because the liberation rate of the metal oxide is in the range of 30 to 60%, the metal oxide adheres to the untransferred residual toner on the photoreceptor before that untransferred residual toner forms a toner dam and cleaning is well performed with the cleaning device, resulting in effectively preventing the occurrence of filming. When the liberation rate of the metal oxide is less than 30%, the good cleaning property for removing untransferred residual toner is less effective and the effect of removing a toner dam that is a cause of the occurrence of filming cannot be obtained. And, when the liberation rate of the metal oxide is more than 60%, excessive loads are applied on cleaning devices including a blade and adversely affect their maintenance.

Further, the measurement of the liberation rate of the metal oxide in the second toner can be performed using the same method as measuring the liberation rate of the electrically conductive powder in the first toner.

And, as a method for controlling the liberation rate of the metal oxide in the range, controlling by adjusting the surface hardness of the toner particles can be used, and the same method as controlling the liberation rate of the electrically conductive powder in the first toner can be used.

Then, specific examples of the metal oxide will be cited. As usable metal oxides according to the invention, for example, silica, aluminum oxide, zinc oxide, titanium oxide, tin oxide, iron oxide and the like can be exemplified. Among these, silica is particularly preferable. As reasons that silica is preferable, silica has high chargeability, consequently it easily adheres to a photoreceptor even in a free state, and it is hard to be transferred because of having properly high electric resistance. Accordingly, it is noted that silica is easily provided to the cleaning part and thereby the effect of the invention is notably obtained.

Further, the silica used according to the invention is preferable to be 80 to 1,000 nm in volume average particle size. When the volume average particle size is less than 80 nm, silica is apt to be difficult to act effectively to reduce non-electrostatic adhesive force. Especially, silica is easily buried into toner particles due to stress in the developing device and sometimes does not match the purpose of liberating the additives of the invention. On the other hand, when the volume average particle size is more than 1,000 nm, silica easily breaks away from toner particles and matches the purpose of liberating the additives of the invention, however the silica is not preferable because it is apt to be hard to adhere to toner remained on the photoreceptor before untransferred residual toner forms a toner dam. The volume average particle size of silica is more preferable in the range of 80 to 500 nm, and particularly preferable in the range of 150 to 300 nm.

Here, in cases where particles to be measured are less than 2 μm in diameter like external additives including the silica, particle measurement is carried out using a laser diffraction type particle size distribution measuring device (LA-700: manufactured by Horiba, Ltd.). in the measuring method, after a sample in the state of dispersion liquid is adjusted to be about 2 g in solid content, ion-exchange water is added in the sample to make about 40 ml. The sample liquid is poured into a cell until a proper concentration is obtained. After about 2 minutes, the concentration in the cell is confirmed to be almost stable and then the measurement is carried out. Obtained volume average particle sizes are accumulated every channel from the small particle side, and the channel where the rate of the cumulative number reaches 50% is determined to be the volume average particle size.

And, the silica is preferable to be mono-dispersed and spherical. Mono-dispersed spherical silica is dispersed uniformly on the surface of toner particles to give stable spacer effect. Here, the definition of monodispersity according to the invention can be discussed with the standard deviation of average particle sizes of particles containing aggregates. The standard deviation is preferable to be less than D50×0.22, where D50 is volume average particle seize. And, the definition of the spherical shape according to the invention can be discussed with the conglobation degree of Wadell, the conglobation degree is preferable to be 0.6 or more, and more preferable to be 0.8 or more.

Mono-dispersed spherical silica having a volume average particle size of 80 to 1,000 nm according to the invention can be obtained through the sol-gel process that is a wet process. Since being manufactured by a wet process and without burning, the true specific gravity of the silica can be controlled to be lower than that of silica manufactured by the vapor phase oxidation method. Further, the true specific gravity may be further adjusted by controlling the treating agent species for hydrophobicization or the amount to be treated in the step of treatment for hydrophobicization. Particle size can be freely controlled by hydrolysis in the sol-gel process, and by the weight ratio of alkoxysilane, ammonia, alcohol and water, the reaction temperature, the agitating speed, and the speed of supply in the condensation polymerization process. Silica's monodispersity and spherical shape can also be achieved by manufacturing it with this procedure.

Concretely, tetramethoxysilane is added in an alcohol aqueous solution containing aqueous ammonia as a catalyst while the solution is heated, and the solution is agitated. Then, the centrifugal separation of the silica sol dispersion obtained by the reaction is carried out to separate the dispersion into a wetting silica gel, alcohol and aqueous ammonia. A solvent is added in the wetting silica gel to make it again in the state of a silica sol, and then the silica surface is made to be hydrophobic by adding a treating agent for hydrophobicization. As a treating agent for hydrophobicization, a general silane compound can be used. Then, the solvent is removed from the silica sol for treating for hydrophobicization, and the silica sol is dried and sieved to give the objective mono-dispersed spherical silica. Moreover, thus obtained silica may be treated again. The method for manufacturing the mono-dispersed spherical silica according to the invention should not be limited to the method.

As the silane compounds, water soluble ones can be used. As such silane compounds, compounds represented by the following formula (A) can be exemplified.:
RₐSiX_{4-n:} Formula (A)
wherein “a” is an integer of 0 to 3, “R” indicates hydrogen atom, or an organic group such as alkyl group and alkenyl group, and “X” indicates chlorine atom, or a hydrolyzable group such as methoxy group and ethoxy group.

As the silane compounds, any type of chlorosilane, alkoxysilane, silazane, and special silanizing agents can be used. Concretely, the following compounds can be illustrated as representative examples; methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethydiethoxysilane, phenyltriethoxysilane, diphenyldiethoxysilane, isobutyltrimethoxysilane, decyltrimethoxysilane, hexamethyldisilazane, N,O-bis(trimethylsilyl)acetamide, N,Nbis(trimethylsilyl)urea, tertbutyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-nercaptopropyltrimethoxysilane, and γ-chloropropyltrimethoxysikane. As treating agents for hydrophobicization according to the invention, particularly preferably, dimethyldimethoxysilane, hexamethyldisilazane, methyltrimethoxysilane, isobutyltrimethoxysilane, decyltrimethoxysilane, and the like can be exemplified.

Moreover, in order to control the fluidity and chargeability of toner, it is preferable to coat sufficiently the surface of toner particles. Because the enough coating might not be able to be obtained only by the silica, it is preferable to use an inorganic compound in small particle size or an organic powder together with the silica. As inorganic compounds in small particle size, inorganic compounds of 80 nm or less in volume average particle size are preferable, and those of 50 nm or less are more preferable. Concretely, for example, all particles generally used as external additives for the toner surface including alumina, titania, calcium carbonate, magnesium carbonate, tricalcium phosphate and cerium oxide can be exemplified. As organic powders, for example, all particles generally used as external additives for the toner surface including polyvinyl resins, polyester resins, silicone resins and fluorocarbon resins can be exemplified. Moreover, a lubricant may be added. As lubricants, for example, fatty amides, including ethylenebisstearic amide and oleic amide, and fatty metal salts, including zinc stearate and calcium stearate, can be exemplified.

The Composition of Toner Particles

Then, the composition of electrostatic latent image developing toner of the invention, in which toner the first toner and second toner are contained, will be described. The toner particles according to the invention contain at least a binder resin and a colorant.

Binder Resins

As binder resins to be used, homopolymers and copolymers of the following monomers can be illustrated: styrenes, including styrene and chlorostyrene; monoolefins, including ethylene, propylene, butylene and isoprene; vinylesters, including vinyl acetate, vinyl propionate, vinyl benzoate and vinyl butyrate; α-methylene aliphatic monocarboxylates, including methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers, including vinyl methyl ether, vinyl ethyl ether and vinyl butyl ether; vinyl ketones, including vinyl methyl ketone, vinyl hexyl ketone and vinyl isopropenyl ketone, and the like.

As especially representative binder resins, polystyrene, styrene-alkyl acrylate copolymers, styrene-alkyl methacrylate copolymers, styrene-acrylonitrile copolymer, styrene-butadiene copolymer, styrene-maleic anhydride copolymer, polyethylene, polypropylene, and the like can be exemplified. In addition, polyesters, polyurethanes, epoxy resins, silicone resins, polyamides, modified rosins, paraffin wax, and the like can be exemplified.

Moreover, a binder resin is preferable to be excellent in sharp melt property at the time of being fixed, and it is preferable to use an amorphous resin and a crystalline resin at the same time in view of gaining a fixing property at low temperatures and a high gloss property in a fixed image.

Further, the amorphous resin indicates such a resin that has not a definite endothermic peak but only stepwise endothermic change in thermal analysis measurement with the use of a differential scanning calorimeter (DSC), and is solid at ordinary temperature and is thermally plasticized at temperatures equal to or more than glass transition temperature. And, the crystalline resin indicates such a resin that has not stepwise endothermic change but a definite endothermic peak in a differential scanning calorimeter (DSC).

As the amorphous resin, the illustrated resins can be used, however it is preferable to use amorphous polyester resins in view of chargeability.

As the crystalline resin, there is especially no limitation if it is a resin with crystallinity. Concretely, crystalline polyester resins, crystalline polyvinyl resins and the like can be exemplified., however crystalline polyester resins are preferable in view of adhesive property to paper and chargeability at the time of being fixed, and melting point adjustment in a preferable range. And, an aliphatic crystalline polyester resins having moderate melting points are more preferable.

The crystalline polyester resin is synthesized from an acid (dicarboxylic acid) component and an alcohol (diol) component. According to the invention, “a component derived from acid” indicates a composing part that is an acid component before the synthesis of the polyester resin and “a component derived from alcohol” indicates a composing part that is an alcohol component before the synthesis of the polyester resin. According to the invention, in case of a polymer in which an other component is copolymerized to the main chain of the crystalline polyester, when the other component is 50% by mass or less, this copolymer is also referred to as crystalline polyester.

As the components derived from acids, aliphatic dicarboxylic, acids are desirable, and straight-chain carboxylic acids are especially desirable. As straight-chain carboxylic acids, for example, oxalic acid, malonic acid, succinic acid, glutaric acid, adipic acid, pimelic acid, suberic acid, azelic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, 1,18-octadecanedicarboxylic acid, and the like, or their lower alkylesters and acid anhydrides can be exemplified. Among them, those of 6 to 10 in carbon number are preferable in view of their crystal melting points and chargeability. In order to raise crystallinity, it is preferable to use these straight-chain dicarboxylic acids in 95 mole % or more in acid components, and more preferable to use them in 98 mol % or more.

As other monomers, there is especially no limitation, for example, there are conventionally well known bivalent carboxylic acids and bivalent alcohols, that are monomer components described in Polymer Data Handbook: “Basic Edition” (Edited by The Society of Polymer Science, Japan: Baifukan CO, LTD.). As specific examples of these monomer components, as for bivalent carboxylic acids, for example, dibasic acid including phthalic acid, isophthalic acid, terephthalic acid, naphthalene-2,6-dicarboxylic acid, naphthalene-2,7-dicarboxylic acid and cyclohexanedicarboxylic acid, and their anhydrides and lower alkylesters can be exemplified. One kind of these compounds may be used alone, and two kinds or more may be used at the same time.

As the components derived from acids, it is preferable that components including components derived from dicarboxylic acids having a sulfonic acid group are contained, besides aforementioned components derived from aliphatic dicarboxylic acids. the dicarboxylic acids having a sulfonic acid group are useful because color materials of a pigment and the like can be well dispersed. Further, when a resin's fine grain dispersion liquid is prepared by emulsifying or suspending a whole resin in water, the existence of a sulfonic acid group makes it possible to prepare the emulsion or suspension without the use of a surfactant as described later. As such dicarboxylic acids having a sulfonic acid group, for example, sodium 2-sulfoterephthalate, sodium 5-sulfoisophthalate, sodium sulfosuccinate and the like can be exemplified, but not limited to them. Further, these lower alkylesters, acid anhydrides, and the like can also be cited. Among these compounds, sodium 5-sulfoisophthalate and the like are preferable in view of cost. The content of the dicarboxylic acid having a sulfonic acid group is preferable to be 0.1 to 2.0 component mol %, and more preferable to be 0.2 to 1.0 component mol %. When the content is more than 2 component mol %, chargeability might deteriorate. Here, “component mol %” according to the invention indicates the percentage when each component (components derived from acids, and components derived from alcohols) in a polyester resin is 1 unit (mol), respectively.

As alcoholic components, aliphatic dialcohols are desirable, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-dodecanediol, 1,12-undecanediol, 1,13-tridecanediol, 1,14-tetradecanediol, 1,18-octadecanediol, 1,20-eicosanediol and the like can be exemplified. Among them, those of 6 to 10 in carbon number are preferable in view of their crystal melting points and chargeability. In order to raise crystallinity, it is preferable to use these straight-chain dialcohols in 95 mole % or more in alcohol components, and more preferable to use 98 mol % or more.

As other bivalent dialcohols, for example, bisphenol A, hydrogenated bisphenol A, bisphenol A ethylene oxide adduct or (and) bisphenol A propylene oxide adduct, 1,4-cyclohexanediol, 1,4-cyclohexanedimethanol, diethylene glycol, propylene glycol, diporpylene glycol, 1,3-butanediol, neopentyl glycol and the like can be exemplified. One kind of these compounds may be used alone, and two kinds or more may be used at the same time.

Further, if necessary, for the purpose of adjusting acid number and hydroxyl number and the like, monovalent acids including acetic acid and benzoic acid, monovalent alcohols including cyclohexanol and benzyl alcohol, benzenetricarboxylic acid, naphthalenetricarboxylic acid and the like, and their anhydrides and their lower alkylesters, trivalent alcohols including glycerin, trimethylolethane, trimethylolpropane and pentaerythritol can be used.

The polyester resins can be synthesized in optional combination of components from the monomer components, with the use of any conventionally well known method described in, for example, Polycondensation (the Kagakudojin), Polymer Experimental Study (polycondensation and polyaddition: KYORITSU SHUPPAN CO,.LTD), Polyester Resin Handbook (edited by Nikkan Kogyo Shimbun, Ltd.) and the like. The ester interchange method, the direct polymerization method and the like can be used independently, or in combination. When the acid component and alcohol component are reacted, the mol ratio (acid component/alcohol component) is different depending on reaction conditions and the like and cannot be unconditionally decided, but is usually about 1/1 in direct polycondensation, and in the ester interchange method, such monomers that can be removed under vacuum as ethylene glycol, neopentyl glycol, cyclohexanedimethanol are often excessively used. The production of the polyester resins are usually carried out at polymerization temperatures of 180 to 250° C., and if necessary, the pressure within the reaction system is reduced and the reaction is carried out while water and alcohol generated in the condensation reaction are removed. When the monomer does not dissolve or is not compatible under the reaction temperature, a solvent with a high boiling point may be added as a solbilizing agent to dissolve the monomer. The polycondensation reaction is carried out while the solbilizing agent is removed. When a poor compatible monomer exists in the copolymerization reaction, the poor compatible monomer is previously condensed with an acid or an alcohol, which is in the polycondensation program, and then the polycondensation reaction with the main component is better carried out.

As catalysts usable in the production of the polyester resins, compounds of alkali metals including sodium and lithium, compounds of alkaline earth metals including magnesium and calcium, metal compounds including zinc, manganese, antimony, titanium, tin, zirconium and germanium, phosphite compounds, phosphate compounds, amine compounds and the like can be exemplified. Concretely, sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenyl antimony, tributyl antimony, tin formate, tin oxalate, tetraphenyltin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenyl phosphite, tris(2,4-di-tbutylphenyl)phosphite, ethyltriphenyl phosphonium bromide, triethylamine, triphenylamine and the like can be exemplified. Among these compounds, tin series catalysts and titanium series catalysts are preferable in view of chargeability, and especially dibutyltin oxide is preferably used.

The melting point of the polyester resin is preferable to be 50 to 120° C., and further preferable to be 60 to 110° C. When the melting point is less than 50° C., the storage stability of the toner and that of the toner image after being fixed might become problems. Moreover, when the melting point is higher than 120° C., enough fixing at low temperatures might not be obtained compared to conventional toner. According to the invention, though the melting point of the crystalline polyester resin is measured with a differential scanning calorimeter (DSC) to be described later, when plural melted peaks are shown, the maximum peak is considered to indicate the melting point.

The weight average molecular weight of the crystalline polyester resin is preferable to be in the range of 5,000 to 50,000 in the molecular weight measurement with GPC (gel permeation chromatography), and more preferable to be in the range of 10,000 to 30,000. When the molecular weight is too small, the effect of making the toner plastic becomes strong, leading to an anxiety of the deterioration of the offset. When the molecular weight is too large, the viscosity of melted toner might become high to deteriorate the fixing property at low temperatures.

The acid number of the crystalline polyester resin is preferable to be 3.0 to 25.0 mg KOH/g, more preferable to be in the range of 6.0 to 20.0 mg KOH/g, and further preferable to be in the range of 9.0 to 18.0 mg KOH/g. When the acid number is lower than 3.0 mg KOH/g, the resin lacks stability as particles at the time of being agglomerated, and when more than 25.0 mg KOH/g, the hygroscopic property of the toner increases, and then the toner becomes easy to receive the environmental impact and is not preferable.

The amorphous polyester resin can be obtained by using the same monomer and method as those in the crystalline polyester resin, but it is preferable to use a monomer mainly composed of a dialcohol of bisphenol A series and a dicarboxylic acid of phthalic acid series in view of chargeability and fixing property. Concretely, bisphenol A ethylene oxide adduct, bisphenol A propylene oxide adduct, terephthalic acid and isophthalic acid are mainly used. Moreover, an amorphous polyester resin may have a crosslinked structure within its molecule. As monomers that will form a crosslinked structure, the following acid monomers and alcohol monomers can be exemplified. Acid monomers are carboxylic acids of trivalent or more including benzentricarboxylic acid and naphthalenetricarboxylic acid, unsaturated dicarboxylic acid including maleic acid, fumaric acid, itaconic acid and citraconic acid, and these anhydrides and these lower alkylesters, and alcohol monomers are alcohols of trivalent or more including glycerin, trimethylolethane, trimethylolpropane and pentaerythritol. One kind of these compounds may be used alone, and two kinds or more may be used at the same time.

The weight average molecular weight of the amorphous polyester resin is preferable to be in the range of 5,000 to 30,000 in the molecular weight measurement with GPC, and more preferable to be in the range of 7,000 to 20,000. When the molecular weight is too small, the offset might deteriorate. When the molecular weight is too large, the melt viscosity of the toner might become high to deteriorate the fixing property at low temperatures.

The acid number of the amorphous polyester resin is preferable to be 2.0 to 25.0 mg KOH/g, more preferable to be in the range of 3.0 to 20.0 mg KOH/g, and further preferable to be in the range of 4.0 to 15.0 mg KOH/g. When the acid number is lower than 2.0 mg KOH/g, the resin lacks stability as particles at the time of being agglomerated, and when more than 25.0 mg KOH/g, the hygroscopic property of the toner increases, and then the toner becomes easy to receive the environmental impact and is not preferable.

The glass transition temperature of the amorphous polyester resin is preferable to be in the range of 45° C. to 80° C., more preferable to be in the range of 50° C. to 75° C., and further preferable to be in the range of 55° C. to 65° C. When the glass transition temperature is. too high, the fixing property at low temperatures might be impaired, and when the glass transition temperature is too low, the toner storage stability may be deteriorated.

In the toner particles according to the invention, the content of the crystalline polyester resin in the hole binder resin components is preferable to be 2 to 40 % by mass, and more preferable to be 2 to 20% by mass. When the content of the crystalline polyester resin is less than 2% by mass, the effect of improving the fixing property at low temperatures might not be obtained, and when more than 40% by mass, the hardness of the toner is reduced, thereby the external additive may become easily buried and the life time of the toner might become short. The cause is that the resin strength of the crystalline polyester resin is low at room temperature as compared to that of the amorphous resin because a part of the crystalline resin is in the state of amorphous.

Further, the content of the binder resin in the toner particles is preferable to be 70 to 98% by mass.

Colorants

On the colorants used according to the invention, there is especially no limitation and well-known colorants can be exemplified. It is possible to select a colorant properly according to the purpose. One kind of colorant may be used alone, and two kinds or more of colorants in the same system may be mixed and used. And, two kinds or more of colorants in the different systems may be mixed and used. Further, these colorants may be surface finished and then used.

As specific examples of the colorants to be used, black, yellow, red, blue, purple, green, and white colorants shown as follows can be exemplified.

As black pigments, organic and inorganic colorants such as carbon black, aniline black, active carbon, nonmagnetic ferrite, magnetite can be exemplified.

As blue pigments, organic and inorganic colorants such as iron blue, cobalt blue, alkali blue lake, Victoria blue lake, fast sky blue, indanthrene blue BC, ultramarine blue, phthalocyanine blue, phthalocyanine green can be exemplified.

As yellow pigments, chrome yellow, zinc chromate, yellow iron oxide, cadmium yellow, chrome yellow, fast yellow, fast yellow 5G, fast yellow 5GX, fast yellow 10G, benzidine yellow G, benzidine yellow GR, thren yellow, quinoline yellow, permanent yellow NCG and the like can be exemplified, and as orange color pigment, red chrome yellow, molybdenum orange, permanent orange GTR, pyrazolone orange, vulcan orange, benzidine orange G, indanthrene brilliant orange RK, indanthrene brilliant orange GK and the like can be exemplified.

As red pigments, colcothar, cadmium red, red lead, mercury sulfide, watchung red, permanent red 4R, lithol red, brilliant carmine 3B, brilliant carmine 6B, Dupont oil red, pyrazolone red, rhodamine B lake, lake red C, rose bengal, eoxine red, alizarin lake and the like can be exemplified.; as purple pigments, organic and inorganic colorants including manganese purple, fast violet B and methyl violet lake can be exemplified; and as green pigments, organic and inorganic colorants including chromium oxide, chrome green, pigment green B, malachite green lake and final yellow green G can be exemplified.

As white pigments, zinc white, titanium oxide, antimony white, zinc sulfide and the like can be exemplified. As extenders, baryta powder, barium carbonate, clay, silica, white carbon, talc, alumina white and the like can be exemplified.

Further, the content of the colorant in the toner particles is preferable to be 1 to 15% by mass.

Releasing Agents

Furthermore, a releasing agent can be added in the toner particles according to the invention. As releasing agents to be used, for example, low molecular weight polyolefines including polyethylene, polypropylene and polybutene, silicons that show softening points by heating, fatty amides such as oleic amide, erucic amide, ricinoleic amide, stearic amide, vegetable wax such as carnauba wax, rice wax, candelilla wax, Japan wax, jojoba oil, animal wax such as yellow beeswax, and mineral and petroleum wax such as montan wax, ozokerite, ceresin, paraffin wax, microcrystalline wax, Fischer-Tropsch wax, and those modified products can be exemplified.

According to the invention, as releasing agents, it is preferable to use mineral and petroleum wax such as paraffin wax, microcrystalline wax, Fischer-Tropsch wax, and to use those modified products, polyalkylenes. And, η140, the viscosity of releasing agents at 140° C. that is measured with E type viscometer is preferable to be in the range of 1.5 to 5.0 mPa.s, and more preferable to be in the range of 2.0 to 4.5 mPa.s.

When η140, the viscosity at 140° C. is less than 1.5 mP.s, the following problems might occur: the powder fluidity of the toner deteriorates, the releasing agent layer formed on the image after fixing becomes inhomogeneous to cause uneven peeling, and uneven brightness of the image is visibly generated. And, when the viscosity η is higher than 5.0 mpa.s, because the melt viscosity rises and the elution property of the releasing agent decreases, the releasing agent original merit of low melt viscosity might be lost; at the time of oilless fixing, a releasing agent necessary for demolding cannot be supplied between the image and the fixing members including a fixing roll, to cause defective peeling.

Further, the viscosity of a releasing agent at 140° C., η140 is measured with E type viscometer. At the time of measurement, an E type viscometer equipped with an oil cycloid type constant-temperature bath (made by Tokyo Keiki Co., Ltd.) is used. Here, a cone plate with cone angle of 1.34° is used.

Concretely, the measurement is carried out as follows. First, the temperature of the circulation system is set at 140° C., and an empty cup for measuring a sample, an empty cup for reference and a cone are set in a measuring apparatus and kept at the constant temperature while the oil circulates. Then, when the temperature becomes stable, 1 g of a sample is placed in the cup for measuring a sample and left at rest in the stationary state of the cone for 10 minutes. After becoming stable, the cone is rotated and the measurement is made. The rotation speed of the cone should be 60 rpm. The measurement is made three times, and the average value of measurements is decided to be viscosity η140 at 140° C.

Moreover, on the releasing agent, the maximum peak of the main constituent measured with the differential scanning calorimetry in conformity with ASTM D3418-8 is preferable to be in the range of 85 to 95° C., and further preferable in the range of 86 to 93° C.

When the maximum peak of the main constituent is less than 85° C., the problem such as becoming easy to cause the offset might occur. And, when the maximum peak is more than 95° C., some problems might occur, for example, the smoothness on the surface of the fixed image is not obtained to decrease the gloss because of increasing in the fixing temperature of the toner, and the oilless peeling property decreases because of decreasing in the elution property of the releasing agent.

In the measurement of the maximum peak of the main constituent, for example, DSC-7 made by ParkingElmer Co., Ltd. is used. Melting points of indium and zinc are used for the temperature correction of the primary detecting element in the apparatus, and the heat of fusion of indium is used for the correction of the amount of heat. An aluminum pan is used for a sample and an empty pan is set for control, and then the measurement is made at the temperature rising speed of 10° C./min.

Further, the glass transition temperature and melting point of the binder resin described above are also measured by the same method.

Moreover, the content of a releasing agent in the toner particles that is obtained from the height of the endotherm peak in the maximum endotherm value in the differntial thermal analysis is preferable to be in the range of 5 to 10% by mass, and more preferable in the range of 6.5 to 8.5% by mass.

When the content of the releasing agent is less than 5% by mass, though it is advantageous to the dry treatment of the wetting toner to be described later, the gloss of the image might be decreased because the sufficient amount of elution for peeling is not obtained at the time of oilless fixing to impair the peeling property and generate the surface roughness. And, when the content is more than 10% by mass, the migration of the releasing agent to the surface of the wetting toner becomes easy at the time of drying, consequently, not only the fluidity of the powder of the toner is decreased after drying, but contact traces of the discharge roll and the like are induced at the time of discharging the fixed image, and the image quality might be impaired.

The Method for Manufacturing Toner Particles

Next, the suitable method for manufacturing toner particles according to the invention will be described.

In view of obtaining the color toner being possible to form a full-color image with high image quality and to have a small particle diameter with a sharp particle distribution, it is preferable to obtain the toner particles through the wet manufacturing method comprising of the aggregation process for forming agglomerated particles in the dispersion liquid where at least resin particles and particles of a colorant are dispersed, and the fusion process for fusing the agglomerated particles by heating them.

The aggregation process uses at least the dispersion liquid of resin particles containing the binder resin and the dispersion liquid of colorants containing the colorant. Further if necessary, a dispersion liquid prepared by adding and mixing other components such as the dispersion liquid of a releasing agent is mixed with those dispersion liquids, and then a flocculant is added. Then, the mixture is heated while it is stirred to agglomerate resin particles, the colorant and the like, resulting in forming aggregate particles.

The volume average particle size of the aggregate particles is preferable to be in the range of 2 to 9 μm. In the aggregate particles formed in this way, resin particles (additional particles) may be additionally added to form a coating layer on the surface of the aggregate particles (adhesion process). The resin particles additionally added in this adhesion process need not be the same as those in the dispersion liquid of resin particles used in the aggregation process described above.

Moreover, it is preferable to mix a resin having relatively high molecular weight with resins used in the aggregation process or the adhesion process described above to make an external additive easy to liberate. Concretely, a resin of 100,000 to 500,000 in Mz, Z average molecular weight, is preferable.

Then, in the fusion process, aggregate particles are heated to, for example, a temperature equal to or more than the glass transition temperature of the resin, generally 70 to 120° C. to agglomerate them, resulting in giving a liquid containing toner particles (toner particles dispersion liquid). Then, the obtained liquid containing toner particles is treated by centrifugal separation or suction filtration to separate the toner particles, and the toner particles are ished with ion-exchange water 1 to 3 times. At that time, the ishing effect may be improved by adjusting the pH of the ion-exchange water. After that, the toner particles are filtered, ished with ion-exchange water 1 to 3 times, and dried to give the toner particles to be used as the toner of the invention.

In the first toner of the invention, at least electrically conductive powder is added as an external additive to the toner particles obtained in this way. At that time, the amount of the electrically conductive powder added to the toner particles is preferable to be 0.5 to 10% by mass, and more preferable to be 1 to 7% by mass.

And in the second toner, at least a metal oxide is added as an external additive to the toner particles. At that time, the amount of the metal oxide added to the toner particles is preferable to be 0.3 to 15% by mass, and more preferable to be 1 to 10% by mass.

### EXAMPLES

Hereinafter, the present invention will be described in more detail with examples and comparative examples. However, the invention should not be limited by the following examples and comparative examples. Further, hereinafter “part” and “%” indicate “mass part” and “% by mass” until otherwise specified.

First, the following samples are prepared for manufacturing the toner used in examples 1 to 3 and comparative examples 1 and 2.

The Preparation of a Crystalline Resin Particle Dispersion Liquid

After 98 parts of dimethyl sebacate, 2 parts of dimethyl phthalate-5-sodium sulfonate, 100 parts of 1,6-hexanediol, and 0.3 parts of dibutyltin oxide as a catalyst are placed in a three-neck flask having been heated and dried, the inside of the flask is made to be vacuumed and made to be inert atmosphere with nitrogen gas, and then the mixture is stirred with a mechanical stirrer for 5 hours at 180° C. under reflux.

After that, the temperature of the mixture is raised slowly to 230° C. and the mixture is stirred for 4 hours under reduced pressure. When the mixture becomes viscous, the mixture is air-cooled and the reaction is stopped. The crystalline resin 1 is synthesized in this way. The measurement of the molecular weight of the obtained crystalline resin 1 by gel permeation chromatography (being reduced to polystyrene) shows that the weight average molecular weight (Mw) is 30,000.

Further, the specified molecular weight measurement of particles according to the invention is carried out on the following condition. HLC-8120GPC, SC-8020 (manufactured by Tosoh Corp.) device is used as GPC, 2 columns of TSKgel, Super HM-H (manufactured by Tosoh Corp., 6.0 mm ID×15 cm) are used, and THF (tetrahydrofuran) is used as an eluent. As measurement conditions, the concentration of a sample is 0.5%, the flow rate is 0.6 ml/min., the injection amount of a sample is 10 μl, and measurement temperature is 40° C., and further an IR detector is used. In addition, the calibration curve is drawn by 10 samples of “A-500”, “F-1”, “F-10”, “F-80”, “F-380”, “A-2500”, “F-4”, “F-40”, “F-128”, and “F-700” from “Polystyrene Standard Sample TSK standard” manufactured by Tosoh Corp.

Moreover, when the melting point (Tm) of the crystalline resin 1 is measured using a differential scanning calorimeter (DSC) by the aforementioned measurement method, a distinct endothermic peak is shown and the temperature at the endothermic peak is 66° C.

Next, using a crystalline resin, a crystalline resin particle dispersion liquid is prepared.
Crystalline resin 1: 90 parts.
Ionic surfactant, Neogen RK (manufactured by Daiichi Kogyo Seiyaku Co., Ltd.): 1.8 parts.
Ion-exchange water: 210 parts.

After the mixture of the components is heated to 100° C. and is sufficiently dispersed with Ultratarax T50 manufactured by IKA Corporation, the dispersed processing of the liquid is carried out with a pressure discharge type gorlin homogenizer for 1 hour to give the crystalline resin particle dispersion liquid 1 having the volume average particle size is 130 nm and the amount of solid content is 30%. Further, the volume average particle size is measured using a laser diffraction type particle size distribution measurement device (trade name: LA-700, manufactured by Horiba, Ltd.).

The Preparation of Amorphous Resin Particle Dispersion Liquid 1

Styrene (manufactured by Wako Pure Chemical industries.): 325 parts.

n-butyl acrylate (manufactured by Wako Pure Chemical industries.): 100 parts.

Acrylic acid (manufactured by Rhodia Nicca Co., Ltd.): 13 parts.

1,10-decanediol diacrylate (manufactured by Shin Nakamura Chemical Co., Ltd.): 1.5 parts.

Dodecanethiol (manufactured by Wako Pure Chemical industries.): 3.0 parts.

The components are mixed in advance and dissolved to prepare a solution. A surfactant solution in which 9 parts of an anionic surfactant (trade name: Dow Fax A211, manufactured by the Dow Chemical Co.) is dissolved in 580 parts of ion-exchange water is put in a flask. Further 400 parts of the solution is put in the flask to disperse and emulsify and, while the mixture is slowly stirred and mixed for 10 minutes, 50 parts of ion-exchange water dissolving 6 parts of ammonium persulfate is put in.

Then, after the air in the flask is sufficiently replaced with nitrogen, the solution in the flask is heated while it is stirred until the temperature becomes 75° C. in an oil bath. The emulsion polymerization in the flask is continued without modification for 5 hours to give amorphous resin particle dispersion liquid 1.

The resin particles are separated from the amorphous resin particle dispersion liquid 1 and their physical properties are investigated. The results show that the volume average particle size is 195 nm, the amount of solid content in the dispersion liquid is 42%, the glass transition temperature is 51.5° C., and the weight average molecular weight (Mw) is 32,000.

The Preparation of Amorphous Resin Particle Dispersion Liquid 2

Styrene (manufactured by Wako Pure Chemical industries.): 320 parts.

n-butyl acrylate (manufactured by Wako Pure Chemical industries.): 115 parts.

Acrylic acid (manufactured by Rhodia Nicca Co., Ltd.): 13 parts.

A solution in which 1.5 parts of an anionic surfactant, Dow Fax (manufactured by the Dow Chemical Co.) is dissolved in 550 parts of ion-exchange water is added in the solution in which the components are mixed and dissolved to disperse and emulsify in a flask and, while the mixture is slowly stirred and mixing for 10 minutes, further, 50 parts of ion-exchange water dissolving 5.5 parts of ammonium persulfate is put in. Then, after the air in the flask is sufficiently replaced with nitrogen, the solution in the flask is heated while it is stirred until the temperature becomes 65° C. in an oil bath. The emulsion polymerization in the flask is continued without modification for 5 hours to give anionic amorphous resin particle dispersion liquid 2. The volume average particle size of the resin particles in the amorphous resin particle dispersion liquid 2 is 170 nm, the amount of solid content is 42.6%, and the weight average molecular weight (Mw) is 217,200.

The Preparation of Colorant Particle Dispersion Liquid

Copper phthalocyanine B15: 3 (manufactured by Dainichiseika Colour & Chemicals Mfg Co., Ltd.): 45 parts.

Cationic surfactant Neogen RK (manufactured by Dai-ichi Kogyo Seiyaku Co., Ltd): 5 parts.

Ion-exchange water: 200 parts.

After the components are mixed and are preliminarily dispersed with a homogenizer (trade name: Ultratarax: manufactured by IKA Corporation) for 10 minutes, the dispersed processing of the mixture is performed using an altimizer (a counter-collision type wet pulverizing machine: manufactured by Sugino Machine Co., Ltd.) under the pressure of 245 mPa for 15 minutes to give a colorant particle dispersion liquid of 385 nm in volume average particle size.

The Preparation of a Releasing Agent Particle Dispersion Liquid

Pentaerythritol behenate wax (melting point is 84.5° C.): 45 parts.

Cationic surfactant Neogen RK (manufactured by Dai-ichi Kogyo Seiyaku Co., Ltd): 5 parts.

Ion-exchange water: 200 parts.

After the mixture of the components is heated to 95° C. and is sufficiently dispersed with Ultratarax T50 manufactured by IKA Corporation, the dispersed processing of the liquid is carried out with a pressure discharge type gaulin homogenizer to give the releasing agent particle dispersion liquid that the volume average particle size is 220 nm and the amount of solid content in the 100 parts is 20%.

The Manufacture of Toner Particles 1-1

Amorphous resin particle dispersion liquid 1: 280 parts.

Colorant particle dispersion liquid: 55 parts.

Releasing agent particle dispersion liquid: 95 parts.

The components are sufficiently mixed and dispersed with Ultratarax T50 in a round-bottom stainless-teel flask to give a solution.

Then, while it is stirred, 0.2 parts of polyaluminum chloride and 0.1 parts of aluminum sulfate are added in the solution to make core agglomerated particles, and dispersing operation is continued with the use of Ultratarax T50. Further, the solution within the flask is heated while it is stirred to 47° C. with a heating oil bath. After keeping the solution at 47° C. for 60 minutes, 100 parts of amorphous resin particle dispersion liquid 1 and 50 parts of amorphous resin particle dispersion liquid 2 are slowly added in the solution to make core/shell agglomerated particles.

After that, 0.5 mol/L of sodium hydroxide aqueous solution is added to adjust pH of the solution to be 6.5, and the stainless steel flask is shut tightly and heated to 98° C. while it is stirred with a magnetic seal. And, after 0.3 mol/L of nitric acid aqueous solution is added to adjust pH of the solution to be 4.2 and then 0.3 moVL of citric acid aqueous solution is added to adjust pH of the solution to be 3.1, then the solution is kept in the state for 5 hours. After that, the solution is cooled and blue toner is obtained.

Next, after the blue toner in the state of dispersing in the solution is filtered and sufficiently wished with ion-exchange water, solid-liquid separation is performed through Nutsche type suction filtration. This separated solid is further dispersed again into 3 L of ion-exchange water kept at 40° C., and is stirred and wished at 300 rpm for 15 minutes.

This operation is further repeated 5 times. And, when pH of the filtrate becomes 7.01 and electric conductivity of the filtrate becomes 15.8 μS/cm, solid/liquid separation is performed using No. 5A filter paper through Nutsche type suction filtration. Solids comprising of the obtained blue toner are dried under vacuum for 12 hours to give toner particles 1-1. The number average particle size distribution index G is 1.18. The number average particle size distribution index G is obtained according to the above-mentioned method.

The Manufacture of Toner Particles 1-2

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 1-2 is manufactured by the same procedure as that for the toner particles 1-1 except for adding 125 parts of amorphous resin particle dispersion liquid 1 and 25 parts of amorphous resin particle dispersion liquid 2 in the adhesion process. The number average particle size distribution index G is 1.16.

The Manufacture of Toner Particles 1-3

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 1-3 is manufactured by the same procedure as that for the toner particles 1-1 except for adding 75 parts of amorphous resin particle dispersion liquid 1 and 75 parts of amorphous resin particle dispersion liquid 2 in the adhesion process. The number average particle size distribution index G is 1.19.

The Manufacture of Toner Particles 14

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 14 is manufactured by the same procedure as that for the toner particles 1-1 except for adding 140 parts of amorphous resin particle dispersion liquid 1 and 10 parts of amorphous resin particle dispersion liquid 2 in the adhesion process. The number average particle size distribution index G is 1.14.

The Manufacture of Toner Particles 1-5

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 1-5 is manufactured by the same procedure as that for the toner particles 1-1 except for adding 25 parts of amorphous resin particle dispersion liquid 1 and 125 parts of amorphous resin particle dispersion liquid 2 in the adhesion process. The number average particle size distribution index G is 1.20.

The Manufacture of Toner Particles 1-6

Crystalline resin particle dispersion liquid: 125 parts.

Amorphous resin particle dispersion liquid 1: 180 parts.

Colorant particle dispersion liquid: 55 parts.

Releasing agent particle dispersion liquid: 95 parts.

The toner particles 1-6 is manufactured by the same procedure as that for the toner particles 1-1 except for adding 20 parts of amorphous resin particle dispersion liquid 1 and 130 parts of amorphous resin particle dispersion liquid 2 in the adhesion process. The number average particle size distribution index G is 1.22.

The Manufacture of a Carrier

Ferrite particles (volume average particle size: 50 μm): 100 parts.

Toluene: 14 parts.

Styrene-methacrylate copolymer (component ratio: 90/10, weight average molecular weight: 80,000): 2 parts.

Carbon black (trade name: R330, manufactured by Cabot Corp.): 0.2 parts.

First, the components except ferrite particles are stirred with a stirrer for 10 minutes to prepare a dispersed coating liquid. Next, after this coating liquid and ferrite particles are put in a vacuum degassing type kneader and stirred at 60° C. for 30 minutes, the mixture is degassed by reducing the pressure while it is warmed further and is then dried to manufacture a carrier.

### Example 1

In 100 parts of the toner particles 1-1, 0.4 parts of cerium oxide (number average particle size: 0.8 μm) as an external additive (electrically conductive powder) and further 3 parts of silica (number average particle size: 0.025 μm) as other external additive are added and blended by a Henschel mixer at peripheral velocity of 22 m/s for 1 minute. Coarse particles are removed from the blended product using a sieve of 45 μm mesh to give electrostatic latent image developing toner. The liberation rate of cerium oxide in the obtained toner is 65%. The liberation rate is obtained according to the above-mentioned method.

5 parts of the obtained electrostatic latent image developing toner and 100 parts of the carrier are stirred at 40 rpm using a V blender for 20 minutes. The mixture is passed through a sieve having 177 μm mesh to give an electrostatic latent image developer.

The obtained developer is put in a developing machine, the remodeled machine (a machine remodeled so that the preset temperature of a fixing machine is variable) of DocuCentre Color 320CP (manufactured by Fuji Xerox Co., Ltd.). Then, after the fixing temperature is set to 150° C. and the running of 15,000 sheets is performed, the surface of the photoreceptor is observed. No occurrence of filming is recognized on the photoreceptor.

### Example 2

Electrostatic latent image developing toner is obtained in the same method except for changing the toner particles 1-1 used in Example 1 to the toner particles 1-2. Further, the liberation rate of cerium oxide in the obtained toner is 54%.

Moreover, an electrostatic latent image developer is obtained in the same method as Example 1, and after performing the running of 15,000 sheets with the same remodeled machine, the surface of the photoreceptor is observed. The occurrence of filming is slightly recognized on the photoreceptor.

### Example 3

Electrostatic latent image developing toner is obtained in the same method except for changing the toner particles 1-1 used in Example 1 to the toner particles 1-3. Further, the liberation rate of cerium oxide in the obtained toner is 76%.

Moreover, an electrostatic latent image developer is obtained in the same method as Example 1, and after performing the running of 15,000 sheets with the same remodeled machine, the surface of the photoreceptor is observed. The occurrence of filming is slightly recognized on the photoreceptor.

### Comparative Example 1

Electrostatic latent image developing toner is obtained in the same method except for changing the toner particles 1-1 used in Example 1 to the toner particles 14. Further, the liberation rate of cerium oxide in the obtained toner is 48%.

Moreover, an electrostatic latent image developer is obtained in the same method as Example 1, and after performing the running of 10,000 sheets with the same remodeled machine, the surface of the photoreceptor is observed. The occurrence of filming is recognized on the photoreceptor.

### Comparative Example 2

Electrostatic latent image developing toner is obtained in the same method except for changing the toner particles 1-1 used in Example 1 to the toner particles 1-5. Further, the liberation rate of cerium oxide in the obtained toner is 93%.

Moreover, an electrostatic latent image developer is obtained in the same method as Example 1, and after performing the running of 10,000 sheets with the same remodeled machine, the surface of the photoreceptor is observed. The occurrence of filming is recognized on the photoreceptor.

### Comparative Example 3

Electrostatic latent image developing toner is obtained in the same method except for changing the toner particles 1-1 used in Example 1 to the toner particles 1-6. Further, the liberation rate of cerium oxide in the obtained toner is 95%.

Moreover, an electrostatic latent image developer is obtained in the same method as Example 1, and after performing the running of 6,000 sheets with the same remodeled machine, the surface of the photoreceptor is observed. The occurrence of filming is recognized on the photoreceptor.

The Preparation of Mono-Dispersed Spherical Silica Particles

Then, silica sol obtained by the sol-gel process is treated with HMDS, and then is dried and pulverized to give mono-disperse spherical silica that the conglobation degree ψ=0.85 and the volume average particle size D50=135 nm (the standard deviation=29 nm).

Further, the particle size of the silica particles is measured using a laser diffraction and scattering type particle size distribution measurement device (HORIBA LA410).

Further, the conglobation degree ψ is calculated from the true conglobation degree of Wadell (the following formula (B)).
Conglobation degree ψ=A/B Formula (B)

A: The surface area of a sphere having the same volume as an actual particle.

B: The surface area of an actual particle.

The “A” is calculated from the volume average particle size. The “B” is substituted for BET surface area that is measured using Shimadzu powder-specific surface area measurement instrument SS-100 type.

The Manufacture of Toner Particles 2-1

Amorphous resin particle dispersion liquid 1: 280 parts.

Colorant particle dispersion liquid: 55 parts.

Releasing agent particle dispersion liquid: 95 parts.

The components are sufficiently mixed and dispersed with Ultratarax T50 in a round-bottom stainless-steel flask to give a solution.

Then, while this solution is mixed, 0.1 parts of aluminum sulfate is added in the solution and at 1 minute later, further 0.2 parts of polyaluminum chloride is added to make core agglomerated particles, and dispersing operation is continued with the use of Ultratarax T50. Further, the solution within the flask is heated while it is stirred to 47° C. with a heating oil bath. After keeping the solution at 47° C. for 60 minutes, 100 parts of amorphous resin particle dispersion liquid 1 and 50 parts of amorphous resin particle dispersion liquid 2 are slowly added into the solution to make core/shell agglomerated particles.

After that, 0.5 mol/L of sodium hydroxide aqueous solution is added to adjust pH of the solution to be 6.5, and the stainless steel flask is shut tightly and heated to 98° C. while it is stirred with a magnetic seal. And, after 0.3 mol/L of nitric acid aqueous solution is added to adjust pH of the solution to be 4.2 and then 0.3 mol/citric acid aqueous solution is added to adjust pH of the solution to be 3.1, the solution is kept in the state for 5 hours. After that, the solution is cooled and blue toner is obtained.

Next, after the blue toner in the state of dispersing in the solution is filtered and sufficiently wished with ion-exchange water, solid-liquid separation is performed through Nutsche type suction filtration. This separated solid is further dispersed again into 3 L of ion-exchange water kept at 40° C., and is stirred and wished at 300 rpm for 15 minutes.

This operation is further repeated 5 times. And, when pH of the filtrate becomes 7.01 and electric conductivity of the filtrate becomes 15.8 μS/cm, solid-liquid separation is performed using No. 5 filter paper through Nutsche type suction filtration. Solids comprising of the obtained blue toner are dried under vacuum for 12 hours to give toner particles 2-1. The number average particle size distribution index G is 1.16.

The Manufacture of Toner Particles 2-2

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 2-2 is manufactured by the same procedure as that for the toner particles 2-1 except for adding 125 parts of amorphous resin particle dispersion liquid 1 and 25 parts of amorphous resin particle dispersion liquid 2 in the adhesion process. The number average particle size distribution index G is 1.18.

The Manufacture of Toner Particles 2-3

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 2-3 is manufactured by the same procedure as that for the toner particles 2-1 except for adding 75 parts of amorphous resin particle dispersion liquid 1 and 75 parts of amorphous resin particle dispersion liquid 2 in the adhesion process. The number average particle size distribution index G is 1.21.

The Manufacture of Toner Particles 24

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 24 is manufactured by the same procedure as that for the toner particles 2-1 except for adding 140 parts of amorphous resin particle dispersion liquid 1 and 10 parts of amorphous resin particle dispersion liquid 2 in the adhesion process. The number average particle size distribution index G is 1.20.

The Manufacture of Toner Particles 2-5

Crystalline resin particle dispersion liquid: 115 parts.

Amorphous resin particle dispersion liquid 1: 190 parts.

Colorant particle dispersion liquid: 55 parts.

Releasing agent particle dispersion liquid: 95 parts.

The toner particles 2-5 is manufactured by the same procedure as that for the toner particles 2-1 except for adding 25 parts of amorphous resin particle dispersion liquid 1 and 125 parts of amorphous resin particle dispersion liquid 2 in the adhesion process. The number average particle size distribution index G is 1.25.

### Example 4

In 100 parts of the toner particles 2-1, 3 parts of the mono-dispersed spherical silica is added as an external additive (metal oxide) and blended by a Henschel mixer at peripheral velocity of 22 m/s for 1 minute. Coarse particles are removed from the blended product using a sieve of 45 μm mesh to give electrostatic latent image developing toner. The liberation rate of silica in the obtained toner is 35%.

5 parts of the obtained electrostatic latent image developing toner and 100 parts of the carrier are stirred at 40 rpm for 20 minutes using a V blender. The mixture is passed through a sieve having 177 μm mesh to give an electrostatic latent image developer.

After performing the running of 20,000 sheets using the obtained developer with the same remodeled machine as used in Example 1, the surface of the photoreceptor is observed. The occurrence of filming is slightly recognized on the photoreceptor.

### Example 5

Electrostatic latent image developing toner is obtained in the same method except for changing the toner particles 2-1 used in Example 4 to the toner particles 2-2. Further, the liberation rate of silica in the obtained toner is 45%.

Moreover, an electrostatic latent image developer is obtained in the same method as Example 1, and after performing the running of 20,000 sheets with the same remodeled machine, the surface of the photoreceptor is observed. No occurrence of filming is recognized on the photoreceptor.

### Example 6

Electrostatic latent image developing toner is obtained in the same method except for changing the toner particles 2-1 used in Example 4 to the toner particles 2-3. Further, the liberation rate of silica in the obtained toner is 55%.

Moreover, an electrostatic latent image developer is obtained in the same method as Example 1, and after performing the running of 20,000 sheets with the same remodeled machine, the surface of the photoreceptor is observed. The occurrence of filming is slightly recognized on the photoreceptor.

### Comparative Example 4

Electrostatic latent image developing toner is obtained in the same method except for changing the toner particles 2-1 used in Example 4 to the toner particles 2-4 and changing the operation of the Henschel mixer to at peripheral velocity of 32 m/s for 2 minute. Further, the liberation rate of silica in the obtained toner is 25%.

Moreover, an electrostatic latent image developer is obtained in the same method as Example 1, and after performing the running of 10,000 sheets with the same remodeled machine, the surface of the photoreceptor is observed. The occurrence of filming is recognized on the photoreceptor.

### Comparative Example 5

Electrostatic latent image developing toner is obtained in the same method except for changing the toner particles 2-1 used in Example 4 to the toner particles 2-5 and changing the operation of the Henschel mixer to at peripheral velocity of 15 m/s for 1 minute. Further, the liberation rate of silica in the obtained toner is 70%.

Moreover, an electrostatic latent image developer is obtained in the same method as Example 1, and after performing the running of 10,000 sheets with the same remodeled machine, the surface of the photoreceptor is observed. The occurrence of filming is recognized on the photoreceptor.

As described above, according to the electrostatic latent image developing toner of the invention, the occurrence of filming can be effectively prevented.

<1> An electrostatic latent image developing toner that is made by adding electrically conductive powder as an external additive to toner particles comprising a binder resin and a colorant, wherein the liberation rate of the electrically conductive powder is from 50 to 90%; and

the number average particle size distribution index G of the toner particles, which is represented by the following formula (1), is 1.20 or less,
particle size distribution index G=D50/D16 Formula (1)
wherein the D16 indicates the number average particle diameter of 16% that is the 16th percentile of the particle size distribution measured from the smallest particle size and the D50 indicates the number average particle diameter of 50% that is the 50th percentile of the particle size distribution measured from the smallest particle size.

<2> The electrostatic latent image developing toner according to the <1> comprising an aliphatic crystalline polyester resin as the binder resin.

<3> The electrostatic latent image developing toner according to the <1>, comprising an amorphous polyester resin as the binder resin.

<4> The electrostatic latent image developing toner according to the <2>, wherein the melting point of the crystalline polyester resin is from 50 to 120° C.

<5> The electrostatic latent image developing toner according to the <2>, wherein the content of the crystalline polyester resin in the binder resin is from 2 to 40% by mass.

<6> The electrostatic latent image developing toner according to the <2>, wherein the weight-average molecular weight of the crystalline polyester resin is from 5,000 to 50,000.

<7> The electrostatic latent image developing toner according to the <2>, wherein the acid value of the crystalline polyester resin is from 3.0 to 25.0 mg KOH/g.

<8> The electrostatic latent image developing toner according to the <3>, wherein the weight-average molecular weight of the amorphous polyester resin is from 5,000 to 30,000.

<9> The electrostatic latent image developing toner according to the <3>, wherein the glass transition temperature of the amorphous polyester resin is from 45 to 80° C.

<10> The electrostatic latent image developing toner according to the <3>, wherein the acid value of the amorphous polyester resin is from 2.0 to 25.0 mg KOH/g.

<11> The electrostatic latent image developing toner according to the <1>, wherein the electrically conductive powder is cerium oxide.

<12> An electrostatic latent image developing toner that is made by adding a metal oxide as an external additive to toner particles comprising a binder resin and a colorant, wherein the liberation rate of the metal oxide is from 30 to 60%.

<13> The electrostatic latent image developing toner according to the <12>, wherein the metal oxide contains mono-dispersed spherical silica having a volume average particle size of 80 to 1,000 nm.

<14> The electrostatic latent image developing toner according to the <12>, wherein the toner contains an aliphatic crystalline polyester resin as the binder resin.

<15> The electrostatic latent image developing toner according to the <12>, wherein the content of the crystalline polyester resin in the binder resin is from 2 to 40% by mass.

<16> The electrostatic latent image developing toner according to the <14>, wherein the melting point of the crystalline polyester resin is from 50 to 120° C.

<17> The electrostatic latent image developing toner according to the <14>, wherein the weight-average molecular weight of the crystalline polyester resin is from 5,000 to 50,000.

<18> The electrostatic latent image developing toner according to the <14>, wherein the acid value of the crystalline polyester resin is from 3.0 to 25.0 mg KOH/g.

What is claimed is:

1. An electrostatic latent image developing toner that is made by adding electrically conductive powder as an external additive to toner particles comprising a binder resin and a colorant, wherein
the liberation rate of the electrically conductive powder is from 50 to 90%; and
the number average particle size distribution index G of the toner particles, which is represented by the following formula (1), is 1.20 or less,
particle size distribution index G=D50/D16 Formula (1)
wherein the D16 indicates the number average particle diameter of 16% that is the 16th percentile of the particle size distribution measured from the smallest particle size and the D50 indicates the number average particle diameter of 50% that is the 50th percentile of the particle size distribution measured from the smallest particle size.

2. The electrostatic latent image developing toner of claim 1, comprising a crystalline polyester resin as the binder resin.

3. The electrostatic latent image developing toner of claim 1, comprising an amorphous polyester resin as the binder resin.

4. The electrostatic latent image developing toner of claim 2, wherein the melting point of the crystalline polyester resin is from 50 to 120° C.

5. The electrostatic latent image developing toner of claim 2, wherein the content of the crystalline polyester resin in the binder resin is from 2 to 40% by mass.

6. The electrostatic latent image developing toner of claim 2, wherein the weight-average molecular weight of the crystalline polyester resin is from 5,000 to 50,000.

7. The electrostatic latent image developing toner of claim 2, wherein the acid value of the crystalline polyester resin is from 3.0 to 25.0 mg KOH/g.

8. The electrostatic latent image developing toner of claim 3, wherein the weight-average molecular weight of the amorphous polyester resin is from 5,000 to 30,000.

9. The electrostatic latent image developing toner of claim 3, wherein the glass transition temperature of the amorphous polyester resin is from 45 to 80° C.

10. The electrostatic latent image developing toner of claim 3, wherein the acid value of the amorphous polyester resin is from 2.0 to 25.0 mg KOH/g.

11. The electrostatic latent image developing toner of claim 1, wherein the electrically conductive powder is cerium oxide.

12. An electrostatic latent image developing toner that is made by adding a metal oxide as an external additive to toner particles comprising a binder resin and a colorant, wherein the liberation rate of the metal oxide is from 30 to 60%.

13. The electrostatic latent image developing toner of claim 12, wherein the metal oxide contains mono-dispersed spherical silica having a volume average particle size of 80 to 1,000 nm.

14. The electrostatic latent image developing toner of claim 12, wherein the toner contains a crystalline polyester resin as the binder resin.

15. The electrostatic latent image developing toner of claim 12, wherein the content of the crystalline polyester resin in the binder resin is from 2 to 40% by mass.

16. The electrostatic latent image developing toner of claim 14, wherein the melting point of the crystalline polyester resin is from 50 to 120° C.

17. The electrostatic latent image developing toner of claim 14, wherein the weight-average molecular weight of the crystalline polyester resin is from 5,000 to 50,000.

18. The electrostatic latent image developing toner of claim 14, wherein the acid value of the crystalline polyester resin is from 3.0 to 25.0 mg KOH/g.
